(19) United States
(12) Patent Application Publication
(10) Pub. No.: US 2015/0271278 A1
(43) Pub. Date: Sep. 24, 2015

(54) DISPLAY DEVICE CONNECTED TO NETWORK, DISPLAY SYSTEM AND STORAGE MEDIUM

(71) Applicant: CASIO COMPUTER CO., LTD., Tokyo (JP)

(72) Inventor: Tamotsu IRIE, Tokyo (JP)

(73) Assignee: CASIO COMPUTER CO., LTD., Tokyo (JP)

(21) Appl. No.: 14/623,873

(22) Filed: Feb. 17, 2015

(30) Foreign Application Priority Data
Mar. 20, 2014 (JP) 2014-057836
Dec. 22, 2014 (JP) 2014-258709

(51) Int. Cl. H04L 29/08; H04L 12/927

(52) U.S. Cl. CPC H04L 67/16; H04L 47/80

(57) ABSTRACT

A display device includes: a storage unit, a reception unit, a comparison unit and a control unit. The storage unit stores preregistered position information. The reception unit receives position information sent from a terminal device. The comparison unit compares the received position information with the stored position information. The control unit displays display information on a display unit on the basis of a result of the comparison made by the comparison unit.

### CROSS-REFERENCE TO RELATED APPLICATIONS

This application is based upon and claims the benefit of priority under 35 USC 119 of Japanese Patent Application Nos. 2014-057836 filed on Mar. 20, 2014 and 2014-258709 filed on Dec. 22, 2014, the entire disclosure of which, including the specifications, claims, drawings and abstracts, is incorporated herein by reference in its entirety.

### BACKGROUND OF THE INVENTION

1. Field of the Invention

The present invention relates to a display device connected to a network, a display system and a storage medium.

2. Description of the Related Art

There is described in Japanese Patent Application Laid-Open Publication No. 2002-049556 a system to send image signals from an information processing device via a network to a display device connected to the network so as to display images at a remote place.

While the system to display images by remote control on a display device connected to a network is convenient for a plurality of users to share the display device, there is a need to put restriction on users who can use the display device. The restriction may be put by credentials such as an ID (identification) and a password. However, this allows any user to use the display device no matter where the user is as long as the user has obtained the credentials, and therefore a user at an inappropriate location cannot be excluded from the users who can use the display device.

An object of the present invention is, in the case of displaying images by remote control on a display device connected to a network, to prevent a user at an inappropriate location from displaying images on the display device.

### SUMMARY OF THE INVENTION

According to a first aspect of the present invention, there is provided a display device including: a storage unit which stores preregistered position information; a reception unit which receives position information sent from a terminal device; a comparison unit which compares the received position information with the stored position information; and a control unit which displays display information on a display unit on the basis of a result of the comparison made by the comparison unit.

According to a second aspect of the present invention, there is provided a display system including a terminal device and a display device connected to each other through a network, the terminal device including: an obtaining unit which obtains position information indicating a current position of the terminal device; and the display device including: a storage unit which stores preregistered position information; a reception unit which receives position information sent from the terminal device; a comparison unit which compares the received position information with the stored position information; and a control unit which displays display information on a display unit on the basis of a result of the comparison made by the comparison unit.

According to a third aspect of the present invention, there is provided a storage medium which makes a computer of a display device function as: a reception unit which receives position information sent from a terminal device; a comparison unit which compares the received position information with preregistered position information stored by a storage unit; and a control unit which displays display information on a display unit on the basis of a result of the comparison made by the comparison unit.

### BRIEF DESCRIPTION OF THE DRAWING

The present invention is fully understood from the detailed description given hereinafter and the accompanying drawings, which are given by way of illustration only and thus are not intended to limit the present invention, wherein:

FIG. 1 shows the configuration of a network including a display system of the present invention;

FIG. 2 is a block diagram showing the main control configurations of display devices and terminal devices which constitute the display system of the present invention;

FIG. 3 is a flowchart of a position information registration process; and

FIG. 4 is a flowchart of an image acceptance/non-acceptance determination process.

### DETAILED DESCRIPTION OF THE PREFERRED EMBODIMENT

Hereinafter, an embodiment of the present invention is detailed with reference to the drawings. Although various limitations technically preferable for carrying out the present invention are given to the embodiment below, the scope of the present invention is not limited to the embodiment or illustrated examples.

### [Configuration]

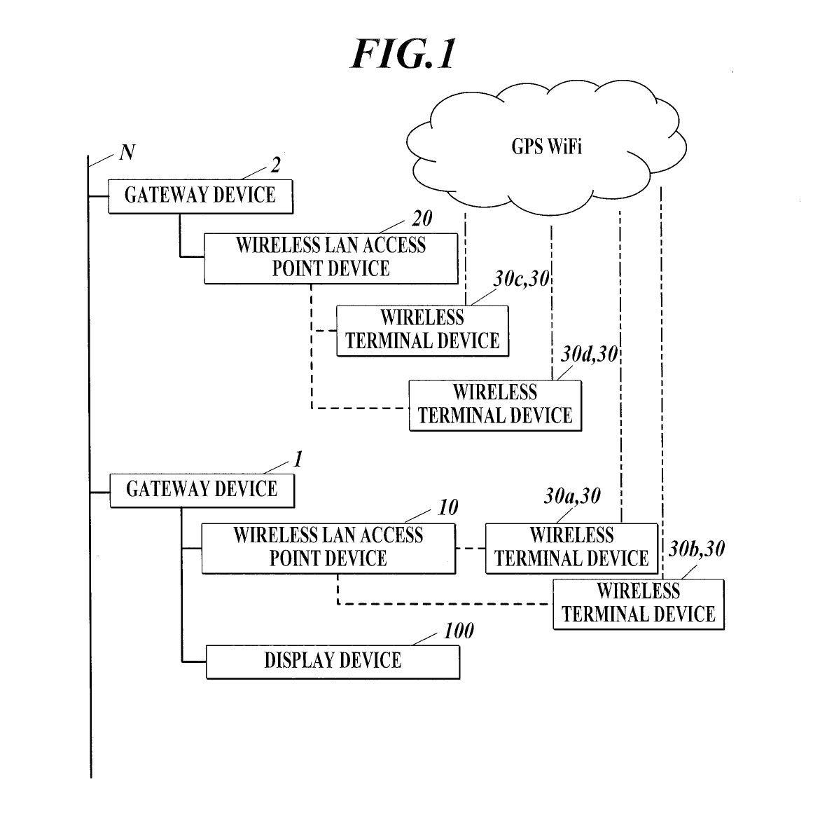

FIG. 1 shows the configuration of a network including a display system according an embodiment of the present invention.

As shown in FIG. 1, a gateway device 1 and a gateway device 2 are connected to each other via a network N.

To the gateway device 1, a wireless LAN (Local Area Network) access point device 10 (“access point 10” hereinafter) and a display device 100 which displays images are connected.

At approximately the same position as the access point 10, one or a plurality of wireless terminal devices 30 (wireless terminal devices 30a and 30b in the embodiment) are present.

To the gateway device 2, a wireless LAN access point device 20 (“access point 20” hereinafter) is connected.

At approximately the same position as the access point 20, one or a plurality of wireless terminal devices 30 (wireless terminal devices 30c and 30d in the embodiment) are present.

Each of the wireless terminal devices 30 can obtain position information indicating the current position of the wireless terminal device 30, for example, through position information service using Wi-Fi® (Wireless Fidelity( ) or wireless relay station information in a school or an office, and also can obtain the position information through GPS (Global Positioning System), Wi-Fi connection service or wireless relay station information outdoors.

The network N is a network to connect the gateway device 1 and the gateway device 2 to each other; for example, a LAN defined by IEEE802.11 standard.

A display system 1000 of the embodiment of the present invention includes the display device 100 and the wireless terminal devices 30.

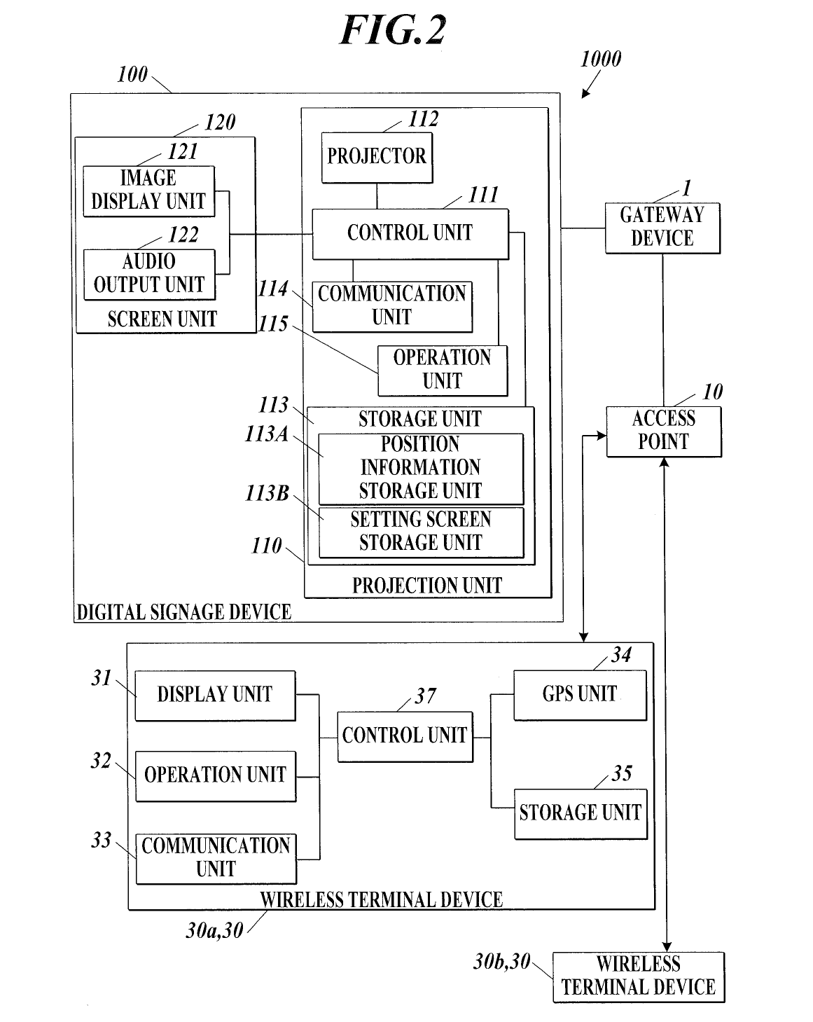

FIG. 2 is a block diagram showing the main control configurations of the display device 100 and the wireless terminal devices 30 which constitute the display system 1000.

In the embodiment, a digital signage device is used as the display device 100. Other examples of the display device 100 include: a projector which displays images by projecting the images to a screen or a wall; and flat displays such as a liquid crystal display and a plasma display.

Each of the wireless terminal devices 30 is, for example, a portable device, and examples thereof include a mobile phone, a smartphone and a tablet terminal. The wireless terminal devices 30a to 30d of the embodiment are the same in the basic configuration.

These devices perform data communication under a communication environment with, for example, http (Hypertext Transfer Protocol) or https (Hypertext Transfer Protocol Secure). As a communication system, https, which encodes http communication with SSL or TLS, is preferred.

The display device 100 includes: a projection unit 110 which emits image light of images; and a screen unit 120 which receives on the back the image light emitted from the projection unit 110 and projects the image light to the front.

The projection unit 110 include: a control unit 111 which controls the units of the display device 100 on the basis of content data composed of images and/or audios; a projector 112 which is connected to the control unit 111, and converts image data output from the control unit 111 into image light and emits the image light to the screen unit 120; a storage unit 113 which stores therein various programs and various content data; a communication unit 114 which communicates with the gateway device 1; and an operation unit 115 which receives user operations.

The screen unit 120 includes: an image display unit 121 constituted of a translucent plate or the like disposed approximately at right angles with an emission direction of image light; and an audio output unit 122 constituted of a speaker or the like. The audio output unit 122 is connected to the control unit 111 by a cable or the like so as to transmit audio signals thereto.

The control unit 111 includes: a not-shown CPU (Central Processing Unit) which performs predetermined arithmetic operations and controls the units of the display device 100 by executing various programs; and a not-shown memory which serves as a work area at the time of the execution of the programs.

The control unit 111 stores in the storage unit 113 position information sent from a wireless terminal device 30 when a position information registration process to register the position information is performed in response to user operations. With this configuration, the control unit 111 functions as a storage unit together with the storage unit 113.

Further, the control unit 111 performs an image acceptance/non-acceptance determination process to determine whether or not to accept (receive) display information (image signals) sent from a wireless terminal device 30. When receiving position information which is sent from the wireless terminal device 30 prior to the display information, the control unit 111 compares the received position information with the position information stored in the storage unit 113 so as to determine whether or not these two pieces of the position information indicate approximately (substantially) the same position.

When determining that the two pieces of the position information indicate approximately the same position, the control unit 111 receives the display information and makes the screen unit 120 output images and/or audios. With this configuration, the control unit 111 also functions as a reception unit and a comparison unit.

Note that “the two pieces of the position information indicate approximately the same position” means that the position indicated by the received position information is within a predetermined distance from the position indicated by the position information stored in the storage unit 113.

The storage unit 113 includes a position information storage unit 113A and a setting screen storage unit 113B.

In the position information storage unit 113A, the position information sent from the wireless terminal device 30 when the position information registration process is performed in response to user operations is registered and stored.

In the setting screen storage unit 113B, a setting screen which is sent to the wireless terminal device 30 to register position information is stored.

In the storage unit 113, a WEB (World Wide Web) server program for operating the setting screen on a WEB screen and the like are also stored.

The operation unit 115 is constituted of, for example, a remote controller communicable with the control unit 111 by infrared rays or operation keys disposed on the projection unit 110.

Each of the wireless terminal devices 30 includes a display unit 31, an operation unit 32, a communication unit 33, a GPS unit 34, a storage unit 35 and a control unit 37 which controls these units.

The display unit 31 is constituted of, for example, a liquid crystal panel or an organic EL (Electro Luminescence) panel.

The operation unit 32 is constituted of, for example, a touch panel or operation keys.

The communication unit 33 communicates with an access point (the access point 10 or 20 in the embodiment) in accordance with, for example, Wi-Fi, 3G (3^{rd} Generation) or LTE (Long Term Evolution) standard and obtains access point information indicating the position of the access point.

The GPS unit 34 receives radio signals from a GPS satellite and calculates a position, a moving direction and a speed on the basis of the radio signals, thereby measuring the position of the wireless terminal device 30 and obtaining GPS information indicating the longitude and latitude thereof.

In the storage unit 35, an application to communicate with the display device 100 is stored. Examples of the application to communicate with the display device 100 include an image sending application.

In the storage unit 35, the access point information obtained through the communication unit 33 and the GPS information obtained through the GPS unit 34 are also stored as the position information.

The control unit 37 obtains the position information through the communication unit 33 or the GPS unit 34 in response to a user operation. With this configuration, the control unit 37 functions as an obtaining unit together with the communication unit 33 or the GPS unit 34.

When the position information registration process to register position information on the wireless terminal device 30 in the display device 100 is performed in response to user operations, the control unit 37 connects the wireless terminal device 30 to an access point (the access point 10 or 20 in the embodiment) near the wireless terminal device 30 in response to a user operation, and sends the position information stored in the storage unit 35 to the access point.

The control unit 37 starts the image sending application so as to send the display information to the display device 100.

### [Position Information Registration Process]

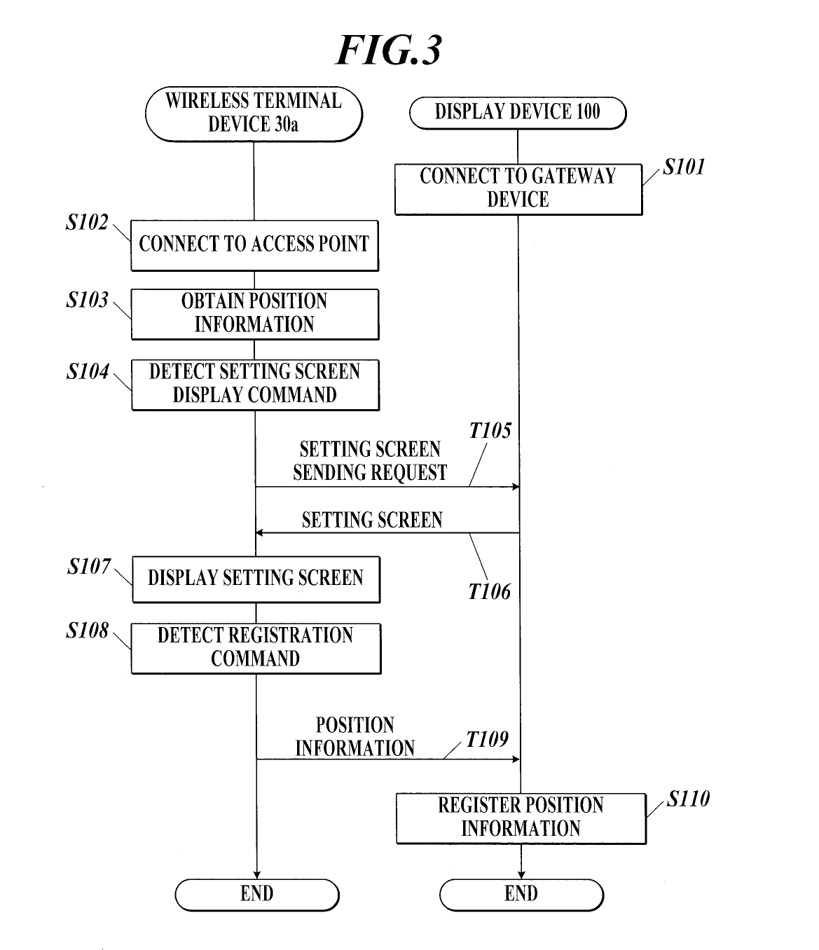

FIG. 3 is a flowchart of a position information registration process to register position information on a wireless terminal device 30 in the display device 100.

In the embodiment, the wireless terminal device 30a is used to register position information.

This position information registration process is performed near the display device 100 installed at a predetermined position in response to operations by a network administrator who operates the network N.

As a precondition for the position information registration process, the gateway device 1 and the access point 10 are connected to each other.

First, the control unit 111 of the display device 100 connects the display device 100 to the gateway device 1 in response to a network administrator (“user” hereinafter) operation (S101).

Next, the control unit 37 of the wireless terminal device 30a connects the wireless terminal device 30a to the access point 10 in response to a user operation (S102).

Next, the control unit 37 of the wireless terminal device 30a obtains access point information as position information through the communication unit 33 (S103).

The registration process is performed near the installation site of the screen unit 120, so that the control unit 37 thereof obtains position information on the position corresponding to the installation site of the screen unit 120.

The obtained position information is stored in the storage unit 35 of the wireless terminal device 30a.

Next, when the user accesses a predetermined URL (Uniform Resource Locator), thereby performing an operation to display the setting screen, which is used for registration of position information in the display device 100, the control unit 37 of the wireless terminal device 30a detects a display command to display the setting screen (“setting screen display command” hereinafter) (S104) and sends a setting screen sending request to the display device 100 (T105).

In order that the wireless terminal device 30a accesses the setting screen of the display device 100, an account name and a password of the network administrator are needed.

When receiving the setting screen sending request from the wireless terminal device 30a, the control unit 111 of the display device 100 reads the setting screen stored in the setting screen storage unit 113B and sends the setting screen to the wireless terminal device 30a (T106).

When receiving the setting screen from the display device 100, the control unit 37 of the wireless terminal device 30a displays the setting screen on the display unit 31 (S107).

When the user performs an operation to register the position information obtained at Step S103 using the setting screen, the control unit 37 of the wireless terminal device 30a detects a registration command to register the position information (“position information registration command” hereinafter) (S108) and sends the position information to the display device 100 (T109).

When receiving the position information from the wireless terminal device 30a, the control unit 111 of the display device 100 stores the position information in the position information storage unit 113A (S110).

Thus, the position information on the installation site of the display device 100 is registered in the display device 100 by the wireless terminal device 30a.

Note that the access to the setting screen, which is necessary for the position information registration process, is a right given to the network administrator only, and the credentials cannot be changed by any general user.

In the case shown in FIG. 3, the control unit 37 of the wireless terminal device 30a obtains the access point information as the position information with the communication unit 33 through the network N. Alternatively, the control unit 37 thereof may obtain GPS information as the position information using the GPS unit 34 or obtain the position information using an external network.

In this case, if the wireless terminal device 30a is connected to the gateway device 1, the wireless terminal device 30a is once disconnected therefrom and connected to the gateway device 1 again after obtaining the position information using the GPS unit 34 or an external network.

### [Image Acceptance/Non-Acceptance Determination Process]

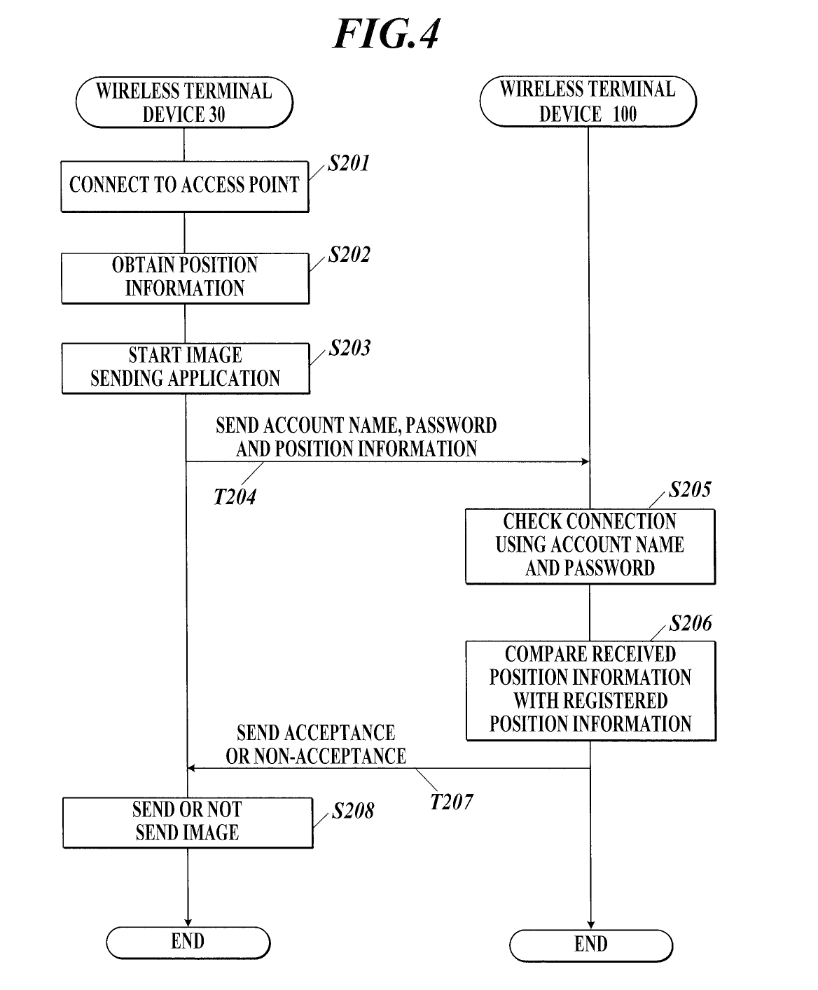

FIG. 4 is a flowchart of an image acceptance/non-acceptance determination process to determine whether or not the display device 100 accepts images from a wireless terminal device 30 so as to display the images.

This image acceptance/non-acceptance determination process is performed in response to operations by a general user who would like to make use of the display device 100.

As a precondition for the image acceptance/non-acceptance determination process, the above-described position information registration process is performed in response to operations by the network administrator, and consequently the position information on the position from which images to display are acceptable (i.e., the position information corresponding to the installation site of the display device 100) is preregistered in the display device 100 by the wireless terminal device 30a.

First, the control unit 37 of a wireless terminal device 30 connects the wireless terminal device 30 to an access point (the access point 10 or 20 in the embodiment) in response to a user operation (S201).

Next, the control unit 37 of the wireless terminal device 30 obtains position information (access point information) through the communication unit 33 in response to an operation by the user who would like to make use of the display device 100 (simply referred to as the “user” hereinafter) (S202).

The obtained position information is stored in the storage unit 35 of the wireless terminal device 30.

In the embodiment, the position information (access point information) is obtained through the communication unit 33. Alternatively, the position information (GPS information) may be obtained using the GPS unit 34, or the position information may be obtained using an external network. In this case, after the position information is obtained using the GPS unit 34 or an external network, the wireless terminal device 30 is connected to the access point.

Next, the control unit 37 of the wireless terminal device 30 starts the image sending application in response to a user operation (S203) and sends an account name, a password and the position information obtained at Step S201 to the display device 100 (T204).

When receiving the account name, the password and the position information from the wireless terminal device 30, the control unit 111 of the display device 100 checks connection using the account name and the password (S205). Note that if the account name and/or the password are incorrect, the control unit 111 of the display device 100 sends error information to the wireless terminal device 30.

Next, the control unit 111 of the display device 100 compares the received position information with the position information preregistered (stored) in the position information storage unit 113A so as to determine whether or not these two pieces of the position information indicate approximately the same position by finding whether or not the two pieces of the position information or are similar to each other (S206).

More specifically, when the received position information is the one sent from the wireless terminal device 30b or the like which is at approximately the same position as the display device 100, the two pieces of the positon information are similar to each other, and therefore it is determined that the two pieces of the position information indicate approximately the same position.

On the other hand, when the received position information is the one sent from the wireless terminal device 30c or the like which is at a position different from the display device 100, the two pieces of the position information are not similar to each other, and therefore it is determined that the two pieces of the position information do not indicate approximately the same position.

Next, the control unit 111 of the display device 100 sends acceptance to the wireless terminal device 30 when determining that the two pieces of the position information indicate approximately the same position, and sends non-acceptance to the wireless terminal device 30 when determining that the two pieces of the position information do not indicate approximately the same position (T207).

The control unit 37 of the wireless terminal device 30 starts sending images to the display device 100 when receiving the acceptance from the display device 100, and does not send images to the display device 100 when receiving the non-acceptance from the display device 100 (S208).

The control unit 37 of the wireless terminal device 30 transmits image signals to the display device 100, thereby sending images to the display device 100, and in response to this, the control unit 111 of the display device 100 outputs images and/or audios with the image display unit 121 and/or the audio output unit 122.

On the other hand, the control unit 37 of the wireless terminal device 30 displays an error message on the display unit 31 when not sending images to the display device 100.

In the above process, the wireless terminal device 30b present at approximately the same position as the wireless terminal device 30a, which has registered position information before, connects itself to the display device 100, so that it is determined that images are acceptable therefrom.

On the other hand, when the wireless terminal device 30c present at a different position (e.g., a different floor or section in the same building, a different building in the same property of a company, etc.) from the wireless terminal device 30a, which has registered position information before, connects itself to the display device 100, it is determined that images are not acceptable therefrom.

In order that the wireless terminal device 30c obtains the acceptance, it is necessary to perform in advance the position information registration process with a wireless terminal device (the wireless terminal device 30c or 30d in the embodiment) around an access point at a position to use (the access point 20 in the embodiment).

The access to the setting screen necessary for the position information registration process is a right given to the network administrator only, and the credentials cannot be changed by any general user. Therefore, the access to the display device 100 for sending images thereto from a different position can be restricted in the network administrator's lap.

As described above, according to the embodiment, the control unit 111 of the display device 100 stores preregistered position information in the storage unit 113, receives with the communication unit 114 position information sent from the wireless terminal device 30, compares the received position information with the stored position information so as to determine whether or not the received position information and the stored position information indicate approximately the same position, and displays display information on the screen unit 120 when determining that the received position information and the stored position information indicate approximately the same position.

Thus, the display device 100, which is connected to the network N, compares (a) the position information sent from the wireless terminal device 30 which is going to output images to the display device 100 with (b) the preregistered position information at the start of the connection by the image sending application. Therefore, the display device 100 can determine whether or not the wireless terminal device 30 is present within a range of the position indicated by the preregistered position information (i.e., a range of approximately the same position).

Consequently, even when the wireless terminal device 30 has succeeded to send/receive images to/from the display device 100 before, the wireless terminal device 30 cannot be connected (i.e., cannot send images) to the display device 100 if the user's whereabouts at the time of the connection is inappropriate.

Meanwhile, even when the user's whereabouts is, for example, a different floor or a different building than before, as long as the position information is preregistered in response to operations by the network administrator with the wireless terminal device 30, the wireless terminal device 30 can be connected (i.e., can send images) to the display device 100.

Consequently, in the case of displaying images by remote control on the display device 100 connected to the network N, a user at an inappropriate location can be prevented from displaying images on the display device 100.

Further, according to the embodiment, the control unit 111 of the display device 100 stores the position information corresponding to the installation site of the screen unit 120 in the storage unit 113 as the preregistered position information, compares the received position information with the stored position information, and determines that the received position information and the stored position information indicate approximately the same position when finding that the received position information and the stored position information are similar to each other.

Consequently, only the wireless terminal device 30 present in the area corresponding to the installation site of the screen unit 120 can be connected to the display device 100.

Further, according to the embodiment, the control unit 111 of the display device 100 stores in the storage unit 113 the position information sent from the wireless terminal device 30 at the installation site of the screen unit 120 as the preregistered position information.

Consequently, only the wireless terminal device 30 present in the area corresponding to the installation site of the screen unit 120 can be connected to the display device 100.

Further, according to the embodiment, when determining that the received position information and the stored position information indicate approximately the same position, the control unit 111 of the display device 100 receives with the communication unit 114 the display information sent from the wireless terminal device 30 which has sent the received position information, and displays the received display information on the screen unit 120.

Consequently, images received from the wireless terminal device 30 which has been determined to be present within a range of approximately the same position can be displayed on the screen unit 120.

In the above embodiment, the network has one display device 100. Alternatively, the network may be configured in such a way that the gateway device 2 is also provided with a display device 100. In this environment where a plurality of display devices 100 are present, images are prevented from being sent to a display device 100 installed in a different position than a terminal device which sends the images.

Further, in the embodiment, by the position information registration process, the position information sent from the wireless terminal device 30 at the installation site of the screen unit 120 is stored in the storage unit 113 as the preregistered position information. Alternatively, predetermined position information at the network administrator's decision may be stored in the storage unit 113.

Further, in the embodiment, the wireless terminal device 30 has the communication unit 33 and the GPS unit 34. However, the wireless terminal device 30 may have one of these as long as the wireless terminal device 30 can obtain the position information.

Further, in the embodiment, the display information is sent from the wireless terminal device 30. Alternatively, the display information may be pre-stored in the display device 100.

In this case, the display information stored in the display device 100 is correlated with position information, and when it is determined in the image acceptance/non-acceptance determination process that the stored position information and position information sent from the wireless terminal device 30 indicate approximately the same position, the display information correlated with the position information sent from the wireless terminal device 30 via the stored position information is read and displayed on the display device 100.

Further, in the embodiment, the wireless terminal device 30 (30a) which registers the position information and the wireless terminal device 30 (30b) which sends images to the display device 100 are different. It is needless to say, however, that the same wireless terminal device 30 can be used to do both of them.

Further, in the embodiment, the wireless terminal devices 30 are used as the terminal devices. Alternatively, cable terminal devices may be used.

Further, in the above embodiment, the received position information and the stored position information are compared to each other. The comparison result is not limited to a result of whether or not these two pieces of the position information indicate approximately the same position. The comparison result means, for example, a result of whether or not the received position information and the position information stored in the storage unit 113 are relevant to each other, which includes a result of whether or not the point indicated by the received position information and the point indicated by the stored position information match.

The following cases are examples which are determined that the received position information and the stored position information are relevant to each other: the point indicated by the received position information is in a predetermined area centering on the point indicated by the position information stored in the storage unit 113; the point indicated by the received position information is in a predetermined district, city or region; and the point indicated by the received position information is in a predetermined area defined by latitudes and/or longitudes. For example, when the two pieces of the position information respectively indicate an A city and a B city which are in the same prefecture, it may be determined that the two pieces of the position information are relevant to each other in terms of the prefecture.

The present invention is not limited to the embodiment, and it can be modified in many ways without departing from the gist at the embodying stage. Further, the functions executed in the embodiment can be appropriately combined as long as they can be executed. The embodiment includes various stages, and various inventions can be extracted by appropriately combining the disclosed constituent elements. For example, even if some of all the constituent elements disclosed in the embodiment are eliminated, a configuration without the eliminated constituent elements can be extracted as an invention as long as the effects can be obtained.

What is claimed is:

1. A display device comprising:
a storage unit which stores preregistered position information;
a reception unit which receives position information sent from a terminal device;
a comparison unit which compares the received position information with the stored position information; and
a control unit which displays display information on a display unit on the basis of a result of the comparison made by the comparison unit.

2. The display device according to claim 1, wherein
the storage unit stores position information corresponding to an installation site of the display unit as the preregistered position information, and
the comparison unit determines that the received position information and the stored position information are relevant to each other when the result of the comparison indicates that the received position information and the stored position information are similar to each other.

3. The display device according to claim 2, wherein the storage unit stores the position information sent from a terminal device at the installation site of the display unit as the preregistered position information.

4. The display device according to claim 2, wherein when the comparison unit determines that the received position information and the stored position information are relevant to each other, the control unit (i) receives the display information sent from the terminal device which has sent the position information received by the reception unit and (ii) displays the received display information on the display unit.

5. The display device according to claim 3, wherein when the comparison unit determines that the received position information and the stored position information are relevant to each other, the control unit (i) receives the display information sent from the terminal device which has sent the position information received by the reception unit and (ii) displays the received display information on the display unit.

6. A display system comprising a terminal device and a display device connected to each other through a network,
the terminal device including:
an obtaining unit which obtains position information indicating a current position of the terminal device; and
the display device including:
a storage unit which stores preregistered position information;
a reception unit which receives position information sent from the terminal device;
a comparison unit which compares the received position information with the stored position information; and
a control unit which displays display information on a display unit on the basis of a result of the comparison made by the comparison unit.

7. A storage medium which makes a computer of a display device function as:
a reception unit which receives position information sent from a terminal device;
a comparison unit which compares the received position information with preregistered position information stored by a storage unit; and
a control unit which displays display information on a display unit on the basis of a result of the comparison made by the comparison unit.
